(19) United States
(12) Patent Application Publication
(10) Pub. No.: US 2026/0318399 A1
(43) Pub. Date: Oct. 15, 2026

(54) Drive Device for a Motor Vehicle and a Mounting Device and a Method for Mounting Such a Drive Device

(71) Applicant: Mercedes-Benz Group AG, Stuttgart (DE)

(72) Inventors: Christian WINDEL, Weinstadt (DE); Markus NAGEL, Waldenbuch (DE); Robin DITTON, Heidelberg (DE)

(21) Appl. No.: 19/105,521

(22) PCT Filed: Aug. 3, 2023
(86) PCT No.: PCT/EP2023/071622

§ 371 Date: Feb. 21, 2025

(30) Foreign Application Priority Data
Aug. 29, 2022 (DE) 10 2022 003 146.9

(51) Int. Cl. F16H 57/00; F16H 1/10; F16H 57/02; F16H 57/023; H02K 7/116; H02K 15/40

(52) U.S. Cl. CPC F16H 57/0025; F16H 1/10; F16H 57/023; H02K 7/116; H02K 15/40; F16H 2057/02034

(57) ABSTRACT

A drive device for a motor vehicle includes an electric engine with a stator, a rotor, and a rotor shaft. A gear wheel is disposed on the rotor shaft which has internal toothing which engages into external toothing of the rotor shaft. The gear wheel has three openings where three holding pins are respectively insertable into the three openings during a mounting of the gear wheel. The rotor shaft has an internal thread at a free end of the rotor shaft. A screw is screwable into the internal thread such that the gear wheel is holdable in the axial direction of the rotor shaft in indirect supporting contact with an abutment of the rotor shaft and such that the gear wheel is fixable to the rotor shaft. A housing has three cavities via which a holding plate that holds the holding pins is fixable to the housing during the mounting.

### BACKGROUND AND SUMMARY OF THE INVENTION

The invention relates to a drive device for a motor vehicle. Furthermore, the invention relates to a mounting device and to a method for mounting such a drive device.

An attachment structure for an output pinion for transmitting a drive of an output power shaft of an internal combustion engine to a chain is taken as known from DE 10 2012 200 185 A1. Furthermore, DE 11 2005 000 616 T5 discloses a method for producing a drive pinion for a motor vehicle differential.

The object of the present invention is to provide a drive device for a motor vehicle and a mounting device and a method for mounting such a drive device, so that particularly simple mounting of the drive device can be implemented.

A first aspect of the invention relates to an, in particular electric, drive device for a motor vehicle, also simply referred to as a vehicle. This means that in its completely produced state, the motor vehicle, preferably formed as a motor car, in particular as a passenger car, has the drive device and can be driven by means of the drive device. The drive device has an electric engine which has a stator and a rotor. The rotor can be driven by means of the stator and thus can be rotated around an engine rotational axis relative to the stator. In particular, the electric engine can provide drive torques via its rotor, by means of which the motor vehicle can be driven, in particular purely electrically. The rotor has a rotor shaft. The drive device also comprises a gear wheel which is formed separately from the rotor shaft and is arranged on the rotor shaft, i.e., at least on a longitudinal region of the rotor shaft. In particular, the gear wheel is a spur gear, in particular a helically toothed spur gear. Thus, the gear wheel has toothing, in particular external toothing, wherein the toothing is preferably formed as helical toothing. In particular, the mentioned longitudinal region is an end region of the rotor shaft, the end region of which is opposite the stator in the axial direction of the rotor shaft, i.e., axially opposite to the stator. Thus, the gear wheel is preferably arranged on an axial end of the rotor shaft opposite the stator. More preferably, the drive device has a spur gear stage, which comprises the gear wheel, in particular as a first gear wheel. Furthermore, for example, the spur gear stage has a second gear wheel, which can be formed as a second spur gear. Preferably, the second spur gear is helically toothed. Preferably, the gear wheels engage with each other, whereby the spur gear stage is formed. The spur gear stage is also referred to as a spur gear transmission stage.

The gear wheel has internal toothing. The rotor shaft has external toothing, also referred to as shaft toothing, in particular in the mentioned end region and thus on the mentioned end. Preferably, the internal toothing of the gear wheel and the shaft toothing are splines. The internal toothing of the gear wheel engages into the corresponding shaft toothing, whereby the gear wheel and the rotor shaft are connected to each other for conjoint rotation. In particular, the internal toothing of the gear wheel is attached by shaft toothing, in particular in the axial direction of the rotor shaft and thus along the mentioned engine rotational axis, around which the rotor and thus the rotor shaft can be rotated relative to the stator.

In order to be able to implement a particularly simple and thus time-efficient and cost-effective mounting of the drive device, in particular of the gear wheel on the rotor shaft, it is provided according to the invention that the gear wheel has at least three openings, in particular through openings, running in the axial direction of the rotor shaft, i.e., parallel to the axial direction of the rotor shaft, which through openings are formed as holes, in particular through holes. Respective holding pins can be inserted into the openings during the mounting of the gear wheel, in particular in the axial direction of the rotor shaft, whereby the holding pins can interact in a form-fitting manner with the gear wheel. Therefore, the gear wheel is or is to be secured against rotation occurring in particular around the engine rotational axis and relative to the stator. In other words, rotation of the gear wheel occurring around in particular the engine rotational axis relative to the stator is or will be prevented thereby. At the free end of the rotor shaft opposite the stator, in particular in the axial direction of the rotor shaft, an internal thread is provided in the rotor shaft as a first thread, in particular formed therein. For example, the internal thread is arranged or formed concentrically to the rotor shaft. A corresponding screw is screwed into the internal thread, in particular in such a way that the screw has an external thread corresponding to the internal thread as a second thread. The second thread is screwed as an internal thread, whereby by means of the screw, the gear wheel is held in the axial direction of the rotor shaft in at least indirect, in particular direct, supporting contact on an abutment of the rotor shaft. The abutment is, for example, arranged on an outer circumference of the rotor shaft. In particular, by screwing the screw into the internal thread of the rotor shaft, the screw presses the gear wheel against the abutment, which is designed, for example, as a collar of the rotor shaft or is formed by a collar of the rotor shaft. As a result, the gear wheel is fixed to the rotor shaft in the axial direction of the rotor shaft, so that relative movements between the gear wheel and the rotor shaft are prevented from occurring in the axial direction of the rotor shaft. The gear wheel is thus both connected to the rotor shaft for conjoint rotation, and also axially fixed to the rotor shaft. The openings, the internal thread and the screw make it possible to fix the gear wheel to the rotor shaft in a particularly time-efficient and cost-effective manner, without causing undesired damage to the electric engine, in particular to a bearing of the electric engine. In particular, the invention makes it possible to both connect the gear wheel to the rotor shaft for conjoint rotation and to axially fix the gear wheel to the rotor shaft, without needing to press the gear wheel onto the rotor shaft. The invention is based on the following findings: The gear wheel cannot be pressed onto the rotor shaft, as otherwise bearings of the electric engine can be damaged. In contrast, the invention makes it possible to fixedly connect the gear wheel to the rotor shaft, in particular both for conjoint rotation and also in the axial direction of the rotor shaft, without having to press the gear wheel onto the rotor shaft. Therefore, the drive device can be mounted time-efficiently, cost-effectively and without damage. A thermal joining of the gear wheel with the rotor shaft, feasible with the aid of nitrogen and/or induction heating for example, is fundamentally conceivable, however very cost-intensive and thus unsuitable for a series process. In contrast, the invention makes it possible to connect the gear wheel to the rotor shaft in a time-efficient and cost-effective manner and thus ready for mass production, without causing damage to bearings of the electric engine.

For example, the openings of the gear wheel are arranged symmetrical to a centre point of the gear wheel, the centre point of which is on the engine rotational axis for example. In particular, it is conceivable that the openings are arranged on an imaginary circle, the centre point of which is on the engine rotational axis and/or coincides with the centre point of the gear wheel. More particularly, it is conceivable that the openings are arranged evenly distributed in the circumferential direction of the gear wheel and the rotor shaft running around the engine rotational axis and thus around the axial direction of the rotor shaft, i.e., spaced apart evenly from each other in pairs. Therefore, the gear wheel and via the gear wheel the rotor shaft can be advantageously secured against undesired torques that occur relative to the stator during mounting.

During mounting, the holding pins are, for example, held on or attached to a holding plate, which is fixed, for example, to a housing of the electric engine. For example, the rotor shaft is at least temporarily arranged on the housing. On the one hand, the holding pins serve to hold the rotor shaft and the gear wheel in place, thus preventing undesired rotation of the rotor shaft and the gear wheel around the engine rotational axis relative to the housing. As a result, the screw can be screwed particularly advantageously and in particular fastened or tightened without causing undesired rotation of the gear wheel and the rotor shaft. On the other hand, for example, the holding pins serve to centre the gear wheel in particular relative to the rotor shaft during mounting. For example, the holding plate is screwed by means of several rods, in particular threaded rods, to the housing also referred to as electric engine housing, and thus attached to the housing, in particular fixed thereto.

In a further embodiment of the invention, the drive device has the mentioned housing of the electric engine in the housing of which the rotor shaft is at least partially arranged.

It has proven to be particularly advantageous in this case when the housing has at least three cavities, by means of which the holding plate provided for holding the holding pins can be or is fixed to the housing during mounting. For example, the respective cavity is designed as a respective hole. For example, it is conceivable that a respective further internal thread is arranged in the respective cavity, into which further internal thread, for example, the respective rod, in particular designed as a threaded rod, can be screwed, in order to fix the respective rod to the housing during mounting. Therefore, a particularly simple and thus time-efficient and cost-effective mounting can be implemented.

A second aspect of the invention relates to a mounting device for mounting, i.e., for mounting a drive device according to the first aspect of the invention. Advantages and advantageous embodiments of the first aspect of the invention are to be regarded as advantages and advantageous embodiments of the second aspect of the invention and vice versa.

The mounting device according to the invention has the mentioned holding plate which has a first, in particular central, through opening. The first through opening is formed as a hole, for example. In particular, the first through opening, which is also referred to as a first opening, is central, in particular in relation to the rotor shaft, so that, for example, the first through opening of the holding plate is arranged concentrically to the rotor shaft when the holding plate is fixed to the housing and/or that the rotor shaft and thus in particular the internal thread is overlapped by the first through opening when viewed in the axial direction. In particular, for example, the holding plate can be pushed onto the rotor shaft, i.e., onto the longitudinal region or onto the aforementioned free end, via the first through opening, in particular in such a way that the longitudinal region or the free end of the rotor shaft can be arranged in the first through opening of the holding plate. Thus, for example, the holding plate can be pushed onto the longitudinal region of the rotor shaft or onto the free end of the rotor shaft in the axial direction of the rotor shaft.

The mentioned screw can be inserted through the through opening, in particular in the axial direction of the rotor shaft, so that then the screw can be screwed into the corresponding internal thread of the rotor shaft, in particular via the first through opening. For example, a screwing tool can penetrate through the first through opening of the holding plate and at the same time screw the screw into the corresponding internal thread of the rotor shaft, wherein, for example, the screwing tool is connected to the screw in a torque-transmitting manner, in particular for conjoint rotation.

The mounting device has the at least or exactly three holding pins which are to be held on or can be fixed to the holding plate, in particular are held or fixed, whereby the holding pins can be or are spatially fixed to the holding plate. The respective holding pin can be inserted through the respective opening of the gear wheel or inserted into this, wherein then if the respective holding pin is inserted through the respective corresponding through opening of the gear wheel or is inserted into this, and is simultaneously fixed to the holding plate, the respective holding pin interacts both with the holding plate and also with the gear wheel in a form-fitting manner. Therefore, the gear wheel and via the gear wheel the rotor shaft are secured in particular against rotation occurring around the engine rotational axis relative to the housing. In this case, the holding device has the aforementioned at least or exactly three rods, which are also referred to as holding rods and, for example, are designed as threaded rods. The holding rods can be or are fixed to the housing of the electric engine, wherein the holding plate is attached to the holding rods. Thus, the holding plate can be fixed to the housing via the holding rods, in particular in such a way that relative movements between the holding plate and the housing of the electric engine are prevented. Therefore, the gear wheel and the rotor shaft via the holding pins, the holding plate and the holding rods can be secured against rotation occurring around the engine rotational axis relative to the housing.

A third aspect of the invention also relates to a method, also referred to as a mounting method, for mounting a drive device, in particular according to the first aspect of the invention, for a motor vehicle. In the method, the drive device is provided which has an electric engine having a stator, a rotor and a housing. In the method, the rotor has a rotor shaft which is at least partially arranged in the housing. In the method, a gear wheel preferably designed as a spur gear is provided which has internal toothing. The gear wheel is arranged on the rotor shaft in such a way that the internal toothing engages into a corresponding external toothing of the rotor shaft, whereby the gear wheel and the rotor shaft are connected to each other for conjoint rotation. For example, the gear wheel is plugged in the axial direction of the rotor shaft onto the rotor shaft, so that the internal toothing of the gear wheel and the external toothing of the rotor shaft are inserted into each other in the axial direction of the rotor shaft. In the method, a holding plate, having at least or exactly three second through openings, of a holding device is provided, wherein the holding plate is fixed to the housing, so that relative movements between the holding plate and the housing are prevented. In the method, the gear wheel has at least or exactly three openings running in the axial direction of the rotor shaft. The feature that the openings run in the axial direction of the rotor shaft is to be understood to mean that the respective opening is continuous along a respective through direction running parallel to the axial direction of the rotor shaft.

A respective holding pin is inserted into the respective opening, which are also inserted through the respective second through opening of the holding plate. Therefore, the holding pins penetrate simultaneously through the second through openings and penetrate into the openings or through the openings, whereby the holding pins interact with the holding plate and with the gear wheel in a form-fitting manner. Therefore, the holding pins secure the gear wheel in a form-fitting manner against a rotation occurring relative to the housing, whereby the rotor shaft is also secured against a rotation occurring relative to the housing.

At its free end which, for example, lies opposite the stator in the axial direction of the rotor shaft, the rotor shaft has an internal thread provided, arranged or formed in the rotor shaft and arranged concentrically to the rotor shaft. A screw is screwed into the internal thread, by means of which the gear wheel is held in at least indirect supporting contact on an abutment of the rotor shaft in the axial direction of the rotor shaft, whereby the gear wheel is fixed to the rotor shaft in the axial direction of the rotor shaft. Advantages and advantageous embodiments of the first and second aspect of the invention are to be regarded as advantages and advantageous embodiments of the third aspect of the invention and vice versa.

In order to be able to mount the drive device in a particularly time-efficient and cost-effective manner, without causing undesired damage, it is provided in one embodiment of the invention that the screw is screwed in at least three in particular temporally successive screw phases in the direction of the gear wheel and thus is rotated in a first rotational direction relative to the rotor shaft, wherein the three screw phases differ from each other in regard to torques with which the screw is screwed and thus is rotated in the first rotational direction of the rotor shaft.

On the one hand, in order to secure the gear wheel particularly tightly axially to the rotor shaft, and on the other hand to avoid damaging the electric engine during the mounting, it is provided in a further embodiment of the invention that there is at least or exactly one releasing phase between at least or exactly two of the screw phases, in which releasing phase the screw is released and therefore is rotated relative to the rotor shaft in a second rotational direction opposing the first rotational direction and thereby unscrewed from the gear wheel at least a bit.

In order to be able to perform the mounting in a time-efficient and cost-effective manner, it is provided in a further embodiment of the invention that the screw is rotated in the releasing phase by at least 80 degrees and at most 100 degrees relative to the rotor shaft, in particular in the second direction, in order to release the screw.

In order to be able to fix the gear wheel securely to the rotor shaft in a time-efficient and cost-effective manner and thus to avoid damaging the electric engine, it is provided in a further embodiment of the invention that in a first of the screw phases, the screw is screwed with at least 25 newton meters at most 35 newton meters, i.e., is rotated in the first rotational direction. In a second of the screw phases temporally following the first screw phase, the screw is rotated with at least 63 newton meters and at most 77 newton meters, in particular in the first rotational direction, relative to the rotor shaft. In a third of the screw phases temporally following the second screw phase, the screw is rotated with at least 135 newton meters and at most 165 newton meters, and thus is rotated in the first rotational direction relative to the rotor shaft and, for example, is fastened, whereby the gear wheel can be securely and fixedly attached to the rotor shaft without damaging the electric engine.

Finally, it has proven to be particularly advantageous when in the first screw phase, the screw is rotated with no more than 200 revolutions per minute, in particular in the first rotational direction, and thereby screwed. Therefore, the mounting can be carried out in a time-efficient and cost-effective manner. It has also been proven to be particularly advantageous when in the second screw phase, the screw is rotated with at most 30 revolutions per minute, in particular in the first rotational direction relative to the rotor shaft, and thereby screwed. Therefore, damage can be reliably avoided. On the one hand, in order to be able to carry out the mounting in a time-efficient and cost-effective manner and on the other hand securely to the extent that damage can be avoided, it is provided in a further embodiment of the invention that in the third screw phase, the screw is rotated with at most 30 revolutions per minute, in particular in the first rotational direction relative to the rotor shaft, and thereby screwed.

Finally, it has been proven to be particularly advantageous when in the releasing phase, the screw is rotated with at most 30 revolutions per minute, in particular in the second rotational direction relative to the rotor shaft, so that excessive loosening of the screw can be reliably avoided. Therefore, the mounting can be carried out in a time-efficient and cost-effective manner.

The gear wheel can be mounted without damaging the electric engine due to the invention. Furthermore, the mounting can be carried out in a time-efficient and cost-effective manner and with a high level of producibility and a low error rate.

Further advantages, features and details of the invention can be seen from the following description of a preferred exemplary embodiment and with reference to the drawings. The features and combinations of features mentioned above in the description as well as the features and combinations of features mentioned below in the description of the figures and/or shown alone in the figures can be used not only in the combination indicated in each case, but also in other combinations or on their own, without leaving the scope of the invention.

### BRIEF DESCRIPTION OF THE DRAWINGS

FIG. 1 is a sectional schematic view of a drive device for a motor vehicle when the drive device is being mounted;

FIG. 2 is a sectional schematic perspective view of the drive device when it is being mounted; and

FIG. 3 is a further sectional schematic perspective view of the drive device when it is being mounted.

### DETAILED DESCRIPTION OF THE DRAWINGS

In the figures, identical or functionally identical elements are provided with the same reference numerals.

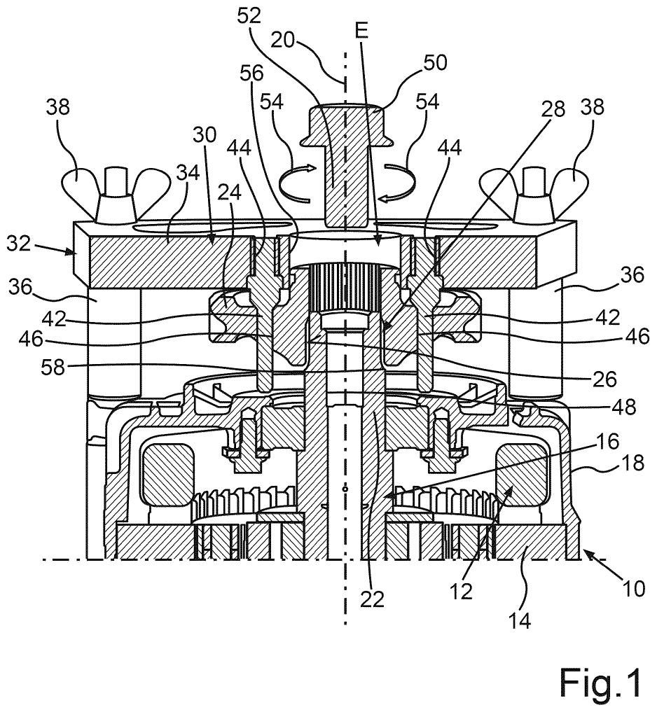

FIG. 1 shows a schematic longitudinal sectional view of an, in particular electrical or electrified, drive device 10 for a motor vehicle, also simply referred to as a vehicle. This means that, in its completely produced state, the motor vehicle has the drive device 10 and can be driven in particular purely electrically by means of the drive device 10. FIG. 1 shows the drive device 10 when mounting the drive device 10. Mounting, i.e., a method for mounting the drive device 10, is explained in more detail in the following using FIG. 1 to 3. It can be seen from FIG. 1 that the drive device 10 has an electric engine 12 which has a stator 14 and a rotor 16 and a housing 18. The rotor 16 is arranged at least partially in the housing 18. Fundamentally, the rotor 16 can be driven by means of the stator 14 and thus can be rotated around an engine rotational axis 20, also simply referred to as a rotational axis, relative to the stator 14 and relative to the housing 18. The engine rotational axis 20 runs in the axial direction of the electric engine 12. The rotor 16 has a rotor shaft 22 via which, for example, the electric engine 12 can provide drive torques to, in particular purely electrically, drive the motor vehicle.

The drive device 10 also has a gear wheel 24 which is provided in the mentioned method. The gear wheel 24 is formed separately from the rotor shaft 22 and is mounted on and to the rotor shaft 22. For this purpose, the gear wheel 24 formed as a spur gear of a spur gear stage has internal toothing 26. The rotor shaft 20 has external toothing 28 corresponding to the internal toothing 26 of the gear wheel 24. In the method, the gear wheel 24 is arranged on the rotor shaft 22 in such a way that the internal toothing 26 engages into the external toothing 28 or vice versa. As a result, the gear wheel 24 and the rotor shaft 22 are connected to each other for conjoint rotation. In particular, the internal toothing 26 and the external toothing 28 are splines which are plugged into each other in the axial direction of the rotor shaft 22 in such a way that the gear wheel 24 is plugged in the axial direction of the rotor shaft 22 onto the rotor shaft 22.

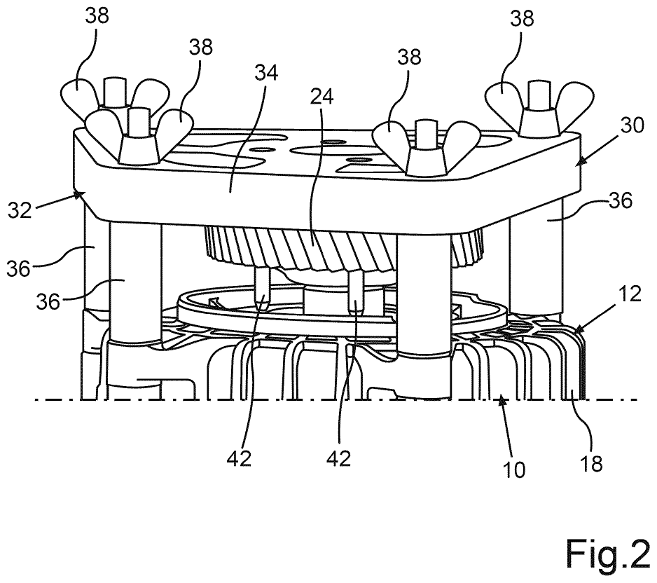

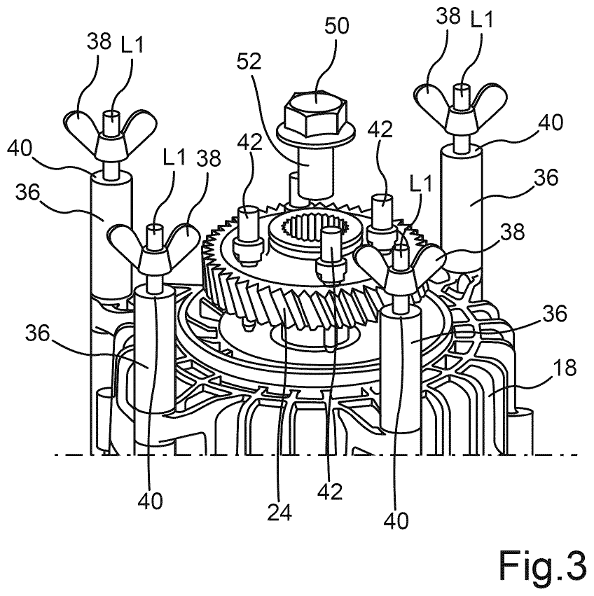

Mounting is carried out by means of a mounting device 30 which has a holding device 32 with a holding plate 34. It can be seen particularly well from FIGS. 2 and 3 that the holding plate 34 has three second through openings. The holding plate 34 is fixed to the housing 18 by fixing the holding plate 34 to the housing 18 by means of holding rods 36 of the holding device 32. For this purpose, the holding rods 36 are screwed to the housing 18 and are thereby fixed to the housing 18. The holding plate 34 has third through openings into which respective longitudinal regions L1 of the holding rods 36 are inserted. While the longitudinal regions L1 penetrate through the corresponding third through openings of the holding plate 34, nuts 38, designed in the present case as wing nuts, are screwed onto the longitudinal regions L1 on a side of the holding plate 34 facing away from the housing 18, by means of which the holding plate 34 is tensioned against respective abutments 40 of the holding rods 36. As a result, the holding plate 34 is fixed to the housing 18.

The gear wheel 24 has at least three openings, in the present case at least or exactly four. In the method, holding pins 42 of the holding device 32 are provided. The openings of the gear wheel 24 run in the axial direction of the rotor shaft 22. The holding pins 42 are inserted through the second through openings of the holding plate 34 and through the openings of the gear wheel 24, so that, as can be seen from FIG. 1, the holding pins 42 simultaneously engage into the second through openings of the holding plate 34, marked with 44 in FIG. 1, and into the openings of the gear wheel 24, marked with 46 in FIG. 1, and in the present case the holding pins 42 penetrate through the openings 46 of the gear wheel 24. Thus, the holding pins 42 interact both with the gear wheel 24 and also with the holding plate 34 in a form-fitting manner, whereby the gear wheel 24 and via this the rotor shaft 22 are secured against rotations occurring around the engine rotational axis 20 relative to the housing 18.

The rotor shaft 22 has an internal thread 48 on its free end E in particular opposite the stator 14 in the axial direction of the rotor shaft 22. The internal thread 48 is arranged concentrically to the rotor shaft 22 or to the engine rotational axis 20. A screw 50 designed in the present case as a colourful screw is provided, which has an external thread 52 corresponding to the internal thread 48. As is illustrated in FIG. 1 by arrows 54, the screw 50 is screwed in via its external thread 52 and the corresponding internal thread 48. For this purpose, the holding plate 34 has a central, first through opening 56 through which the screw 50 is inserted in the axial direction of the rotor shaft 22. Then, the screw 50 is rotated in particular in a rotational direction around the engine rotational axis 20 relative to the rotor shaft 22, in order to thereby screw the screw 50 into the corresponding internal thread 48 via its external thread 52. As a result, the gear wheel 24 is held in the axial direction of the rotor shaft 22 in at least indirect, in particular direct, supporting contact with an abutment 58 of the rotor shaft 22 by means of the screw 50, whereby the gear wheel 24 is fixed to the rotor shaft in the axial direction of the rotor shaft 22. It can be seen that the respective holding pin 42 is, for example, a respective mounting bolt, which is used as an anti-rotation device, i.e., as a torque support, in order to avoid relative rotations between the rotor shaft 22 and the housing 18 both in the first rotational direction and in a second rotational direction opposing the first rotational direction during the mounting. After the screw 50 has been tightened, in particular with a predetermined or predeterminable screw torque of, for example, 150 newton meters +−15 newton meters, the holding device 32 can be released from the housing 18, in particular in such a way that the holding rods 36 and the holding plate 34 and the holding pins 42 are removed. Subsequently, the rotor shaft 22 and the gear wheel 24 connected to the rotor shaft 22 for conjoint rotation can rotate with the engine rotational axis 20 relative to the housing 18 and relative to the stator 14.

### LIST OF REFERENCE CHARACTERS

10 drive device
12 electric engine
14 stator
16 rotor
18 housing
20 engine rotational axis
22 rotor shaft
24 gear wheel
26 internal toothing
28 external toothing
30 mounting device
32 holding device
34 holding plate
36 holding rod
38 nut
40 abutment
42 holding pin
44 first through opening
46 second through opening
48 internal thread
50 screw
52 external thread
54 arrow
56 fourth through opening
E end

1.-8. (canceled)

9. A drive device (10) for a motor vehicle, comprising:
an electric engine (12) which has a stator (14) and a rotor (16) with a rotor shaft (22); and
a gear wheel (24) disposed on the rotor shaft (22) which has internal toothing (26) which engages into corresponding external toothing (28) of the rotor shaft (22), wherein the gear wheel (24) and the rotor shaft (22) are connected to each other for conjoint rotation;
wherein the gear wheel (24) has three openings (46) running in an axial direction of the rotor shaft (22) and wherein three holding pins are respectively insertable into the three openings during a mounting of the gear wheel (24) to prevent a rotation of the gear wheel
wherein the rotor shaft (22) has an internal thread (48) at a free end (E) of the rotor shaft (22) and wherein the internal thread (48) is disposed concentrically to the rotor shaft (22);
a screw (50), wherein the screw (50) is screwable into the internal thread (48) such that the gear wheel is holdable in the axial direction of the rotor shaft (22) in at least indirect supporting contact with an abutment (58) of the rotor shaft (33) and such that the gear wheel (24) is fixable to the rotor shaft (22) in the axial direction of the rotor shaft (22); and
a housing (18) in which the rotor (16) is disposed at least partially, wherein the housing (18) has three cavities via which a holding plate (34) that holds the holding pins (42) is fixable to the housing (18) during the mounting.

10. A mounting device (30) for mounting the drive device (10) according to claim 9, comprising:
a holding plate (34) which has a through opening (56) through which the screw (50) is insertable;
three holding pins (42) which are holdable on and fixable spatially on the holding plate (34), wherein the three holding pins (42) are respectively insertable into the three openings (46) of the gear wheel (24); and
three holding rods (36) which are fixable to the housing (18), wherein the holding plate (34) is attachable to the three holding rods (36).

11. A method for mounting the drive device (10) according to claim 9, comprising the steps of:
inserting three holding pins (42) respectively through three openings of a holding plate (34) and respectively into the three openings (46) of the gear wheel (24) such that the three holding pins (42) penetrate through the three openings of the holding plate (34) and penetrate into the three openings (46) of the gear wheel and such that the three holding pins (42) secure the gear wheel (24) against rotation relative to the housing (18);
moving the screw (50) through a through opening (56) of the holding plate (34); and
screwing the screw (50) into the internal thread (48) of the rotor shaft (22) such that the gear wheel (24) is held in the axial direction of the rotor shaft (22) in at least indirect supporting contact with the abutment (58) of the rotor shaft (22) and such that the gear wheel (24) is fixed to the rotor shaft (22) in the axial direction of the rotor shaft (22).

12. The method according to claim 11, wherein the screwing has at least three successive screw phases in a first rotational direction and wherein the at least three successive screw phases differ from each other in regard to a respective torque with which the screw (50) is screwed.

13. The method according to claim 12, wherein there is a releasing phase between two of the at least three successive screw phases and wherein in the releasing phase the screw (50) is rotated in a second rotational direction.

14. The method according to claim 13, wherein the screw (50) is rotated in the second rotational direction by at least 80 degrees and at most 100 degrees relative to the rotor shaft (22).

15. The method according to claim 12, wherein:
in a first screw phase of the at least three successive screw phases, the screw (50) is screwed with at least 25 newton meters and at most 35 newton meters;
in a second screw phase of the at least three successive screw phases following the first screw phase, the screw (50) is screwed with at least 63 newton meters and at most 77 newton meters; and
in a third screw phase of the at least three successive screw phases following the second screw phase, the screw (50) is screwed with at least 135 newton meters and at most

165. newton meters.

16. The method according to claim 15, wherein:
in the first screw phase, the screw (50) is rotated with no more than 200 revolutions per minute;
in the second screw phase, the screw (50) is rotated with at most 30 revolutions per minute; and
in the third screw phase, the screw (50) is rotated with at most 30 revolutions per minute.
